(19) United States
(12) Patent Application Publication
(10) Pub. No.: US 2002/0067481 A1
(43) Pub. Date: Jun. 6, 2002

(54) Transmission spectroscopy apparatus for vessels

(76) Inventors: Udo Wolf, Kempen (DE); Friedrich-Karl Bruder, Krefeld (DE); Jurgen Diefendahl, Neukirchen-Vluyn (DE); Andreas Elschner, Mulheim (DE); Uwe Hucks, Alpen (DE); Detlef Riesebeck, Duisburg (DE); Bodo Schnittka, Moers (DE); Manfred Schraut, Krefeld (DE); Lutz Spauschus, Kerken (DE)

Correspondence Address: BAYER CORPORATION, PATENT DEPARTMENT, 100 BAYER ROAD, PITTSBURGH, PA, 15205, US

(21) Appl. No.: 09/899,706

(22) Filed: Jul. 5, 2001

(30) Foreign Application Priority Data
Jul. 10, 2000 (DE) 10033457.1

(51) Int. Cl. G01J 3/42

(52) U.S. Cl. 356/325

(57) ABSTRACT

An apparatus for the spectroscopic analysis of the composition of the contents of vessels, especially of conduits, by recording transmission spectra is described. The apparatus comprises at least a radiation source for generating the measuring radiation, and a spectral analyzer for measuring the transmitted radiation, two windows which are disposed opposite one another on the vessel and are transparent to the measuring radiation, and two collimators which are designed to spread the measuring radiation within the range of the measuring section and are disposed opposite one another in front of the windows, characterized in that the collimators are positioned relative to one another in a mounting joined to the vessel and the collimators can, while their relative alignment is maintained, be swung out in parallel from the range of the measuring section in the vessel or be displaced and/or be fixed to the mounting, so that the measuring section bypasses the vessel.

### FIELD OF THE INVENTION

The invention relates to an apparatus for the spectroscopic analysis of the composition of the contents of vessels, especially of conduits, by recording transmission spectra. The invention is based on process windows customary for transmission spectroscopy, which are disposed opposite one another on conduits and which permit spectroscopic analysis of the conduit contents.

### BACKGROUND OF THE INVENTION

Particularly effective control of chemical processes is possible if the material compositions in reactors or in conduits are known at all times.

Material composition hereinafter means e.g. the quantitative proportions of individual defined substances in mixtures of materials, but also proportions by weight of molecular groups such as e.g. OH groups, amino groups, isocyanate groups, phenolate groups, double bonds etc. in the mixture of substances.

Continuous chemical processes, in contrast to discontinuous processes, are often characterized by mass streams which pass into reactors or other chemical apparatuses, emerge from these, are passed to other reactors or other chemical apparatuses and may even be recycled, so that the end product can be produced.

Frequently, such a continuous process is carried out in liquid or gas phase, and the individual mass streams are transported in conduits. Equally, higher-viscosity materials such as e.g. polymer melts or polymer solutions can be transported in conduits.

If the material composition of liquid products or gases in the conduit can then be determined by an analytical procedure, the continuous process can be monitored and also controlled by means of the quantitative proportions of individual mass streams or certain process-typical parameters (e.g. temperature, pressure) being varied.

To enable a spectroscopic measurement through a conduit, it is first necessary to equip the conduit with windows, which are transparent to the measuring radiation. Such measuring cells, which can be integrated into conduits are commercially available.

Spectrometers, which can be connected to the measuring cells or measuring probes by means of light pipes are likewise commercially available.

A pair of light pipes is used to focus the measuring radiation emitted by the radiation source into a light pipe, which is run to the measuring location. Two beam spreader optics (hereinafter referred to as collimators), which are permanently mounted in front of the measuring cell windows, in the known arrangement, form a transmission measuring section through the conduit. With the aid of a second light pipe, the measuring radiation, after transmission through the conduit, is passed to the spectral analyzer.

To allow information regarding the concentration of a component to be derived from the measured spectrum, a spectral analysis method has to be employed which, as a rule, must be preceded by a calibration.

In the known arrangement, the spectrometer measures “single-channel spectra”. As a rule, it is inadvisable to employ single-channel spectra to produce a calibration and to continuously analyze the conduit contents, since any single-channel spectrum inter alia also comprises the spectral intensity distribution of the light source and the spectral sensitivity characteristics of the detector. If a calibration were to be produced on this basis, e.g. any replacement of the radiation source would very probably require subsequent recalibration, if any deterioration in the analytical accuracy is unacceptable. This approach is uneconomical, given the high cost of performing a calibration.

Because of this, according to standard-procedure spectroscopic measurements, recording of any spectrum is preceded, first of all, by a “reference spectrum” IR(V) being recorded with an empty beam path, after which the sample is inserted into the beam path and the single-channel spectrum of the sample I_{P}(v) is used to calculate the transmission spectrum T(v)=I_{P}(v)/I_{R}(V). Only this transmission spectrum then is invariant e.g. with respect to the spectral intensity distribution of the radiation source. Transmission spectra of this type form the basis for an apparatus-invariant calibration. This procedure is customary inter alia for laboratory spectrometers. To determine the concentrations of individual components from the spectrum it is first of all necessary, as a rule, to convert the transmission spectrum T(v) into the “absorbance spectrum” A(v) via the relationship

A(v)=−log (T(v))

since according to Beer's law it is the absorbance and not the transmission which is proportional to the concentration. The spectra IR(V), I_{P}(v), T(v) and A(v) are usually stored in the computer which forms part of the spectrometer.

It is possible e.g. to use Beer's law to correlate peak heights with concentrations of individual components, but also to employ chemometric methods for spectral analysis. A customary technique for determining concentration data from spectra is the “PLS” (Partial Least Squares) method.

Particularly high measurement accuracy will result from such a calibration if the latter is carried out within the process itself which is to be monitored. This requires a sample of a substance to be drawn as proximately as possible to the spectroscopic measuring location and an independent reference method (e.g. on the basis of gas chromatography (GC), high-pressure liquid chromatography (HPLC), mass spectrometry (MS) or spectroscopic methods) to be available for determining the concentrations of those components which subsequently are to be analyzed online in an automated procedure. According to one option for the calibration procedure, a spectrum is recorded and stored at the same time as a sample is drawn as proximately as possible to the measuring location and is analyzed by means of the reference method. On the basis of a minimum number of stored spectra and the respective associated analysis data, a correlation (“calibration”) is then established. Producing such a calibration as a rule is a relatively laborious and consequently costintensive operation.

Once such a calibration has been completed, spectroscopic measurements can as a rule be performed online in an automated manner, the current analytical values being provided by the measuring system at specific intervals (e.g. every second, every minute, every hour).

However, the analysis results of such an automated spectroscopic measurement cannot be used successfully for process monitoring or control unless their accuracy over the longest possible periods is high enough. Moreover, such an automated spectroscopic measurement cannot be performed economically unless manual interventions into the measuring system are required infrequently or, where necessary, require minimal labor.

One requirement for achieving high analytical accuracy is that the spectrum can be measured not only with as good a signal-to-noise ratio as possible, but also with high reproducibility. This high spectral reproducibility should obtain even if e.g. the light source of the spectrometer used has to be replaced because of aging or a malfunction, or if a light pipe has to be replaced.

A further significant problem of the arrangement known from the prior art is that the reference spectrum I_{R}(v) can be recorded only under certain conditions.

The reference spectrum can, for example, be recorded before the conduit is filled with product, i.e. with an empty conduit. If then, e.g. after replacement of the radiation source, the reference spectrum must be remeasured, it is first necessary to ensure that the measuring section as well as the windows for the measuring radiation are free from product or product residues. This often requires the windows to be removed and to be cleaned manually. In some cases, however, the measuring cell cannot be removed until the entire process has been stopped and the conduit has been emptied and flushed, to prevent any toxic substances present from being released. The problems are similar if an immersion probe is used instead of a measuring cell integrated within the conduit. As a rule, therefore, recording the reference spectrum entails considerable labor or losses in productivity.

Another option of recording a reference spectrum is to short-circuit the light pipe ends running to the collimators. In that case, however, spurious reflections at the light pipe ends (“fringes”) may result in superimposition of not readily reproducible interference levels on the reference spectrum, thus falsifying the latter, with a deleterious effect on the accuracy with which the components to be analyzed can be determined.

Thus, IR, UVNIS and NIR spectroscopy involving pipe joints as known from the prior art is virtually unusable, from economic aspects, for determining the material composition in conduits.

### SUMMARY OF THE INVENTION

It is an object of the present invention to provide a transmission spectroscopy measuring apparatus, which is to avoid the drawbacks of the known measuring arrangement.

In particular, it is an object of the present invention to enable the transmission spectrum of the contents of conduits to be recorded without the conduit having to be opened up or the process having to be interrupted in order to record, as required beforehand, the current reference spectrum.

This object is achieved by employing a mounting or mechanism, which is linked to the conduit and with whose aid:

the two collimators can be fixed relative to one another,

the measuring section defined by the two collimators can nevertheless be reproducibly positioned in two ways, viz. either through the windows of the conduit and/or bypassing the conduit,

the transmission spectrum T(v)=Iₚ₁(v)/I_{R1}(v) being calculated from the quotient of the single-channel spectrum Iₚ₁(v) in position 1 (measured through the conduit) and the single-channel spectrum I_{R1}(v) in position 2 (measured bypassing the conduit) and being used for the subsequent quantitative spectral analysis to determine concentration data or quality data.

### BRIEF DESCRIPTION OF THE DRAWINGS

FIG. 1 shows a cross section through a preferred embodiment of the apparatus according to the invention.

FIG. 2 shows the side view of the measuring apparatus according to FIG. 1.

FIG. 3 shows a variation on the apparatuses according to FIG. 1 with a coolable swivel arm.

FIG. 4 shows the side view of the measuring apparatus according to FIG. 3.

FIG. 5 shows a further variation on the apparatus according to FIG. 1 with a mounting 16.

FIG. 6 shows the side view of the apparatus according to FIG. 5

### DETAILED DESCRIPTION OF THE INVENTION

The invention relates to an apparatus for the spectroscopic analysis of the composition of the contents of vessels, especially of conduits, by recording transmission spectra, which comprises at least a radiation source for generating the measuring radiation, and a spectral analyzer for measuring the transmitted radiation, two windows which are disposed opposite one another on the vessel and are transparent to the measuring radiation, and two collimators which are designed to spread the measuring radiation within the range of the measuring section and are disposed opposite one another in front of the windows, characterized in that the collimators are positioned relative to one another in a mounting joined to the vessel and the collimators can, while their relative alignment is maintained, be swung out in parallel from the range of the measuring section in the vessel or be displaced and/or be fixed to the mounting, so that the measuring section bypasses the vessel.

Preferred is an apparatus in which the mounting of the collimators permits at least two reproducible mounting positions, one of which positions permits transmission through the vessel and the other permits transmission through the surroundings of the vessel or optionally of a reference sample outside the vessel.

In a preferred embodiment of the invention, the spectral analyzer is linked to a central processor in which the transmission spectrum T(v)=I_{P1}(v)/I_{R1}(v) is calculated from the quotient of the single-channel spectrum I_{P1}(v) from the transmission through the vessel contents and the single-channel spectrum I_{R1}(v) from the transmission through the vessel surroundings and is used for a quantitative spectral analysis for determining concentration or quality data.

To simplify assembly or cleaning in a preferred form of the apparatus, the mounting of the collimators is detachably joined to the vessel, especially the conduit.

The use of light pipes allows the delicate spectrometer to be separated spatially from the chemical process. Light pipe technology is, therefore, used advantageously for online monitoring of chemical processes.

Preference is therefore given to an apparatus in which the input and/or the output of the measuring radiation is effected by means of light pipes.

For the purpose of cooling the optical components, for example, in the case of conduits carrying hot melts, mountings in a preferred embodiment of the present invention are provided with a heat exchange unit.

More preferably, the sleeves for the ends of the light pipes are likewise of such a design that they can be temperature-controlled by means of heat exchange units.

The analytical methods capable of obtaining the required information concerning material composition include e.g. near-infrared (NIR) spectroscopy and UVNIS spectroscopy. Within the NIR spectral range (800-2500 nm) and within the VIS range (400-800 nm), light pipes can be used to transmit the measuring radiation. Even in the UV spectral range (200-400 nm), light pipes can be employed (subject to certain restrictions).

More preference is, therefore, given to an apparatus in which the radiation source emits measuring radiation in the NIR spectral range (800-2500 nm), in the VIS spectral range (400-800 nm) or in the UV spectral range (200-400 nm).

The apparatus according to the present invention can be used to record at any time the current reference spectrum required for determining concentration data or quality data, by positioning the measuring section so as to bypass the conduit and by measuring and storing the reference spectrum.

This reference spectrum then contains the effects of spectral intensity distribution of the spectrometer (radiation source, detector, optical components) and of the light pipes and of the collimators. The parameters are, therefore, compensated for. Not compensated for, however, is the possible fouling of the windows of the conduit either on the inside or the outside. The method described should, therefore, be quite unsuitable for continuous monitoring of the conduit contents. Surprisingly, it was nevertheless found that many products transported in the conduit will not result in fouling of the measuring cell windows even over prolonged periods. Even a polymer melt at 300° C. left no significant fouling on the windows after an operating time exceeding one year.

Fouling of the measuring cell windows on the outside, on the other hand, can be prevented e.g. by encapsulation or a blanket of pure nitrogen.

Admittedly, the method described is less suitable, should the product to be analyzed tend to leave deposits on the windows of the conduits within a short period.

The invention also relates to a method of controlling chemical processes by determining the material composition in vessels or especially conduits, using the concentration data obtained to control rates of flow or process-typical parameters, determining the material composition by spectroscopic analysis of the contents of vessels and especially conduits, especially by recording transmission spectra, wherein the transmission measurement is effected by means of two windows through the conduit or the vessel, wherein collimators, which are aligned toward one another, are disposed in front of the windows, said collimators defining a measuring section through the vessel or the conduit and being optically linked, especially via light pipes, to a spectrometer, characterized in that the collimators are positioned relative to one another in a mounting joined to the vessel and the collimators can, while their relative alignment is maintained, be swung out in parallel from the range of the measuring section in the vessel or be displaced and/or be fixed to the mounting, so that the measuring section bypasses the vessel, the reference single-channel spectrum I_{R1}(v) is measured after the beam path defined by the collimators has been adjusted in such a way that said beam path bypasses the vessel, and subsequently the single-channel spectrum I_{P1}(v) is measured, with the measuring section passing through the vessel, the transmission spectrum T(v) is calculated from

T(v)=I_{P1}(v)/I_{P1}(v)

and the absorbance spectrum A(v) is calculated via

A(v)=log T(v)

and the absorbance spectrum is used to determine, by means of known analytical methods, peak height analysis, partial least squares method, the material composition in the vessel at the time the spectrum was recorded.

The invention is described below in more detail, with reference to the figures, by means of the examples which, however, do not constitute any limitation of the invention.

### EXAMPLE 1

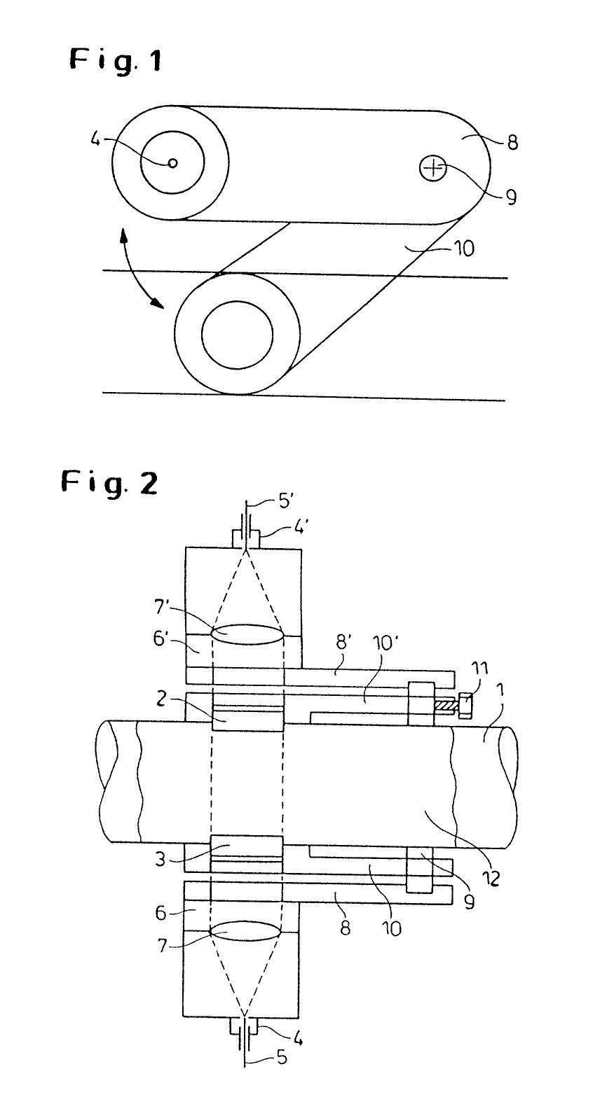

Integrated within a conduit 1 are two windows 2, 3 (See FIGS. 1, 2). Fastened to the conduit 1 are two holders 10, 10′. Running through the holders 10, 10′ is a rotatable shaft 9. Rigidly mounted on this rotatable shaft 9 are two swivel arms 8, 8′. Fastened to each of the swivel arms 8, 8′ is a collimator 6, 6′. The two collimators 6, 6′ face toward one another and are in fixed positions relative to one another. The dimensions chosen are such that rotation of the swivel arms 8, 8′ causes the beam path defined by the collimators 6, 6′ in one position to pass through the windows 2, 3 of the conduit 1 and in another position to bypass the conduit 1. The measuring radiation is directed, from a light source (not shown), via the light pipe 5 embedded in the sleeve 4, directed onto the collimator lens 7 and is spread. Having passed through the measuring section, the radiation is collimated by means of the collimator lens 7′ and is directed onto the light pipe 5′ embedded in the sleeve 4′. The measuring radiation is then passed to the spectral analyzer (not shown).

The single-channel reference spectrum I_{R1}(v) is recorded and stored with the aid of the spectral analyzer, after the beam path defined by the collimators 6, 6′ has been adjusted so as to bypass the conduit 1.

When the conduit 1 is filled with product to be measured, the single-channel spectrum of the sample I_{P1}(v) is measured after the beam path defined by the collimators 6, 6′ has been adjusted so as to pass through the conduit 1 and the product.

The transmission spectrum is calculated according to

T(v)=I_{P1}(v)/I_{R1}(v)

and the absorbance spectrum A(v) is calculated according to

A(v)=−log (T(v))

From the absorbance spectrum, the concentration of the products is calculated by means of known methods (peak height analysis, partial least squares method).

### EXAMPLE 2

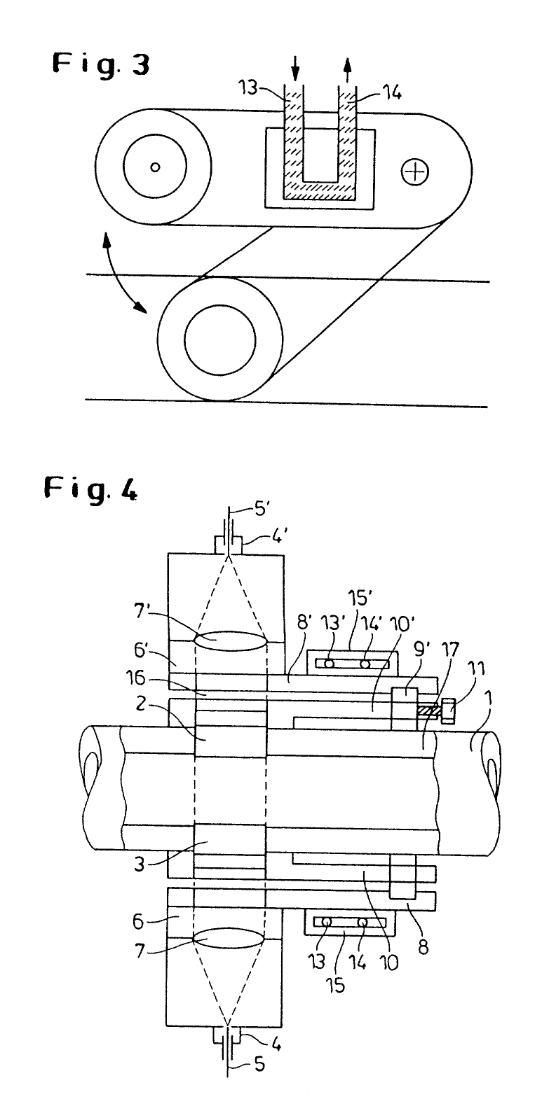

A hot plastic melt (T=350° C.) is conveyed in a conduit 1 which is provided with a jacket heater 17 (See FIGS. 3, 4). The jacket 17 contains a heating medium which envelops the product line 1 proper.

The product within the conduit 1 is analyzed by means of NIR spectroscopy.

The two swivel arms 8, 8′ are equipped with a cooling facility 15, 15′. The cooling facility 15, 15′ consists of a welded-on piece of metal which incorporates a water duct. Via the lines 13, 13′, 14, 14′, fresh cooling water flows through the water duct. As a result of said cooling, the heat-sensitive light pipes 5, 5′ cannot be damaged by heat. Optionally, cool, clean gas (e.g. nitrogen) can be introduced into the interspace 16 between collimator 6, 6′ and window 2 or 3, respectively, to prevent fouling of the windows 2, 3 and to lower the temperature at the light pipe junctions 4, 4′ even further.

The single-channel reference spectrum/I_{R1}(v) is recorded and stored with the aid of the spectral analyzer, after the beam path defined by the collimators 6, 6′ has been adjusted so as to bypass the conduit 1.

With conduit 1 filled, the single-channel spectrum of the sample I_{P1}(v) is measured, after the beam path defined by the collimators 6, 6′ has been adjusted so as to pass through the conduit 1 and the product.

The transmission spectrum is calculated according to

T(v)=I_{P1}(v)/I_{R1}(v)

and the absorbance spectrum A(v) is calculated according to

A(v)=−log (T(v))

From the absorbance spectrum, the concentration of the components in the products to be measured is calculated by means of known methods (peak height analysis, partial least squares method).

### EXAMPLE 3

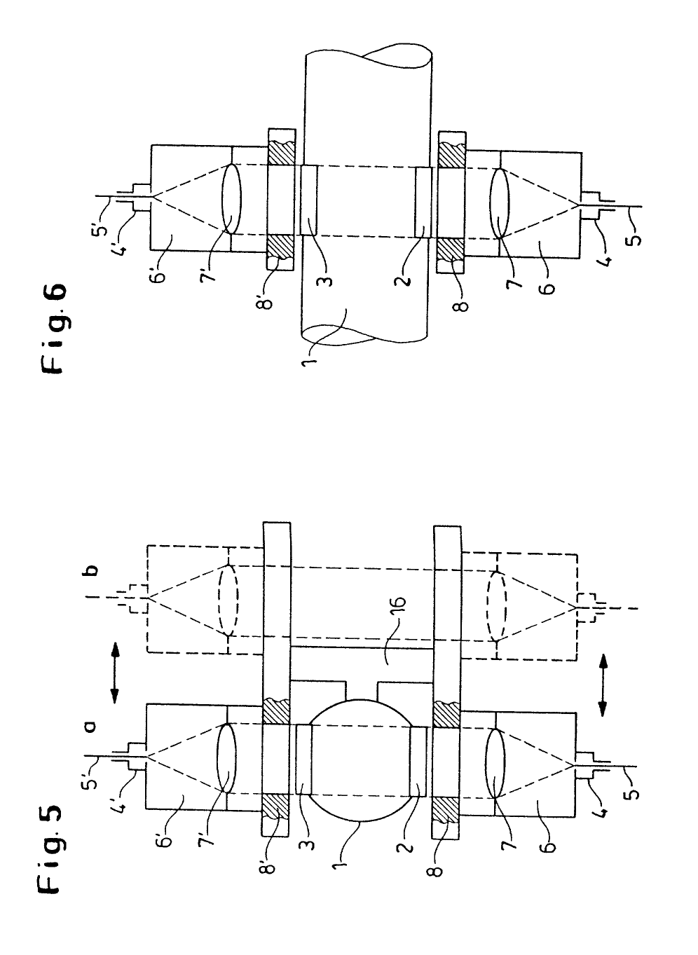

Integrated within a conduit 1 are two windows 2, 3. Fixed to the conduit 1 is the mounting 16 on which the collimator holders 8, 8′ are disposed (See FIGS. 5, 6). The collimator holders 8, 8′ can accommodate the two collimators 6 and 6′ in two positions a and b each. In both positions the two collimators 6 and 6′ are aligned toward one another. In position a the measuring section passes through the conduit, in position b it bypasses the conduit.

The measuring radiation is directed, from a light source (not shown), via the light pipe 5 embedded in the sleeve 4, directed onto the collimator lens 7 and is spread. Having passed through the measuring section, the radiation is collimated by means of the collimator lens 7′ and is directed onto the light pipe 5′ embedded in the sleeve 4′. The measuring radiation is then passed to the spectral analyzer (not shown).

The single-channel reference spectrum I_{R1}(v) is recorded and stored with the aid of the spectral analyzer, after the by the two collimators 6, 6′ has been adjusted so as to bypass the conduit.

When the conduit 1 is filled with product to be measured, the single-channel spectrum I_{P1}(v) is measured after the beam path defined by the collimators 6, 6′ has been adjusted so as to pass through the conduit 1 and the product.

The transmission spectrum is calculated according to

T(v)=I_{P1}(v)/I_{R1}(v)

and the absorbance spectrum A(v) is calculated according to

A(v)=−log (T(v))

From the absorbance spectrum, the concentration of the products is calculated by means of known methods (peak height analysis, partial least squares method).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. An apparatus for the spectroscopic analysis of the composition of the contents of vessels, by recording transmission spectra, which comprises at least a radiation source for generating the measuring radiation, and a spectral analyzer for measuring the transmitted radiation, two windows which are disposed opposite one another on the vessel and are transparent to the measuring radiation, and two collimators which are designed to spread the measuring radiation within the range of the measuring section and are disposed opposite one another in front of the windows, wherein said collimators are positioned relative to one another in a mounting joined to the vessel and the collimators can, while their relative alignment is maintained, be swung out in parallel from the range of the measuring section in the vessel or be displaced and/or be fixed to the mounting, so that the measuring section bypasses the vessel.

2. The apparatus according to claim 1, wherein the mounting of the collimators permits at least two reproducible mounting positions, one of said positions permits transmission through the vessel and the other permits transmission through the surroundings of the vessel or optionally of a reference sample outside the vessel.

3. The apparatus according to claim 1, wherein the spectral analyzer is linked to a central processor in which the transmission spectrum T(v)=I_{P1}(v)/I_{R1}(v) is calculated from the quotient of the single-channel spectrum I_{P1}(v) from the transmission through the vessel contents and the single-channel spectrum I_{R1}(v) from the transmission through the vessel surroundings and is used for a quantitative spectral analysis for determining concentration or quality data.

4. The apparatus according to claim 1, wherein the mounting of the collimators is detachably joined to the vessel.

5. The apparatus according to claim 1, wherein the input and/or the output of the measuring radiation is effected by means of light pipes.

6. The apparatus according to claim 1, wherein the mountings are provided with a heat exchange unit.

7. The apparatus according to claim 5, wherein said sleeves for the ends of the light pipes can be temperature-controlled.

8. The apparatus according to claim 1, wherein the radiation source emits measuring radiation in the NIR spectral range (800-2500 nm), in the VIS spectral range (400-800 nm) or in the UV spectral range (200-400 nm).

9. A method of controlling chemical processes by determining the material composition in vessels, using the concentration data obtained to control rates of flow or process-typical parameters, determining the material composition by spectroscopic analysis of the contents of vessels, by recording transmission spectra, wherein the transmission measurement is effected by means of two windows through the conduit or the vessel, wherein collimators, which are aligned toward one another, are disposed in front of the windows, said collimators defining a measuring section through the vessel or the conduit and being optically linked, especially via light pipes, to a spectrometer, wherein the collimators are positioned relative to one another in a mounting joined to the vessel and the collimators can, while their relative alignment is maintained, be swung out in parallel from the range of the measuring section in the vessel or be displaced and/or be fixed to the mounting, so that the measuring section bypasses the vessel, the reference single-channel spectrum I_{R1}(v) is measured after the beam path defined by the collimators has been adjusted in such a way that said beam path bypasses the vessel, and subsequently the single-channel spectrum I_{P1}(v) is measured, with the measuring section passing through the vessel (1), the transmission spectrum T(v) is calculated from
T(v)=I_{P1}(v)/I_{R1}(v)
and the absorbance spectrum A(v) is calculated via
A(v)=−log (T(v))
and the absorbance spectrum is used to determine, by means of known analytical methods, particularly peak height analysis, partial least squares method, the material composition in the vessel (1) at the time the spectrum was recorded.
